(19) United States
(12) Patent Application Publication
(10) Pub. No.: US 2010/0140575 A1
(43) Pub. Date: Jun. 10, 2010

(54) Prying Tool

(76) Inventor: Mou-Tang LIOU, Ta Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/331,532

(22) Filed: Dec. 10, 2008

(51) Int. Cl. B66F 15/00

(52) U.S. Cl. 254/131.5; 254/129

(57) ABSTRACT

A prying tool includes a shank having an engaging portion and two prongs moveably mounted on the engaging portion of the shank and the prongs define a space therebetween such that an item to be pried is received in the space. The prongs are operably moveable so that the space is variable in size. Further, two positioning devices are utilized for holding the two prongs stationary with respect to the engaging portion of the shank respectively.

### BACKGROUND OF THE INVENTION

1. Field of the Invention

The present invention relates to a prying tool of the type which includes two prongs and the prongs define a gap therebetween such that an item to be pried is received in the gap, and in particular, the two prongs are operably moveable in a readily manner.

2. Description of the Related Art

A prying tool of the type which includes two prongs and defines a gap between the two prongs is known. Generally, for the sake of mass production, the gap is fixed in size. But, user sometimes may encounter a situation that the item is too big to be received by the gap or a situation that the gap is too big for user to efficiently pry the item. So, TW Pat. No. M315635 teaches a prying tool including a group of shanks each including a gap differentiated in size from the others. However, it is a trouble to have all the group of shanks in hand, and besides they are not light to be carried around.

The present invention is, therefore, intended to obviate or at least alleviate the problems encountered in the prior art.

### SUMMARY OF THE INVENTION

According to the present invention, a prying tool includes a shank including an engaging portion and a gripping portion connected transversely to the engaging portion. In this regard, user holds the gripping portion when using the prying tool. Two prongs are moveably mounted on the engaging portion of the shank and each includes a connecting portion connected to the engaging portion of the shank and a working portion projected from the connecting portion. The two working portions define a space therebetween such that an item to be pried is received in the space.

The space has a first size when the one of the two prongs is positioned at a proximal end of the shank and the other of the two prongs is positioned at a distal end of the shank. Further, the space has a second size when the two prongs are in proximity to each other. Since the prongs are moveable, the size of the space is thus variable between the first and second sizes.

The prying tool also includes two positioning devices for holding the two prongs stationary with respect to the engaging portion of the shank respectively.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a prying tool in accordance with a first embodiment of the present invention.

FIG. 2 is an exploded perspective view of the prying tool shown in FIG. 1, with a gripping portion of the prying tool shown partially.

FIG. 3 is a cross-sectional view taken along line 3-3 of FIG. 1.

FIG. 4 is another cross-sectional view similar to FIG. 3, but illustrating a position device of the prying tool in another position.

FIG. 5 is a partial, bottom view of the prying tool shown in FIG. 1.

FIG. 6 is another bottom view similar to FIG. 5, but illustrating two prongs of the prying tool in another positions.

FIG. 7 is an exploded, perspective view of a prying tool in accordance with a second embodiment of the present invention, with a gripping portion of the prying tool shown partially.

FIG. 8 is a cross-sectional view taken along line 8-8 of FIG. 7.

FIG. 9 is a perspective view of a prying tool in accordance with a third embodiment of the present invention.

FIG. 10 is a cross-sectional view of line 10-10 of FIG. 9.

FIG. 11 is a perspective view of a prying tool in accordance with a fourth embodiment of the present invention.

FIG. 12 is an exploded, perspective view of the prying tool shown in FIG. 11, with a gripping portion of the prying tool shown partially.

FIG. 13 is a cross-sectional view taken along line 13-13 of FIG. 11.

### DETAILED DESCRIPTION OF THE PREFERRED EMBODIMENT

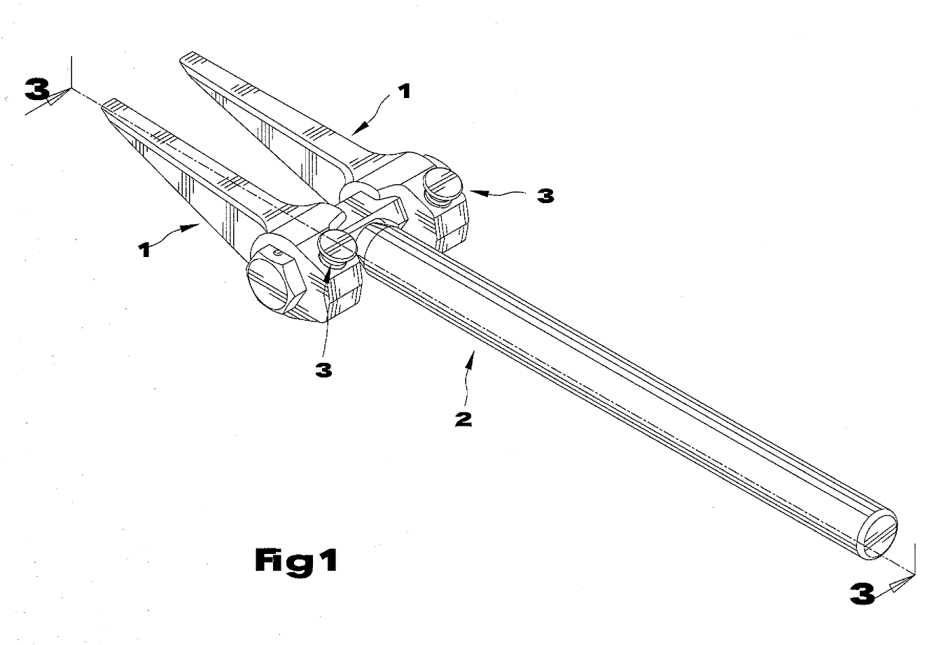

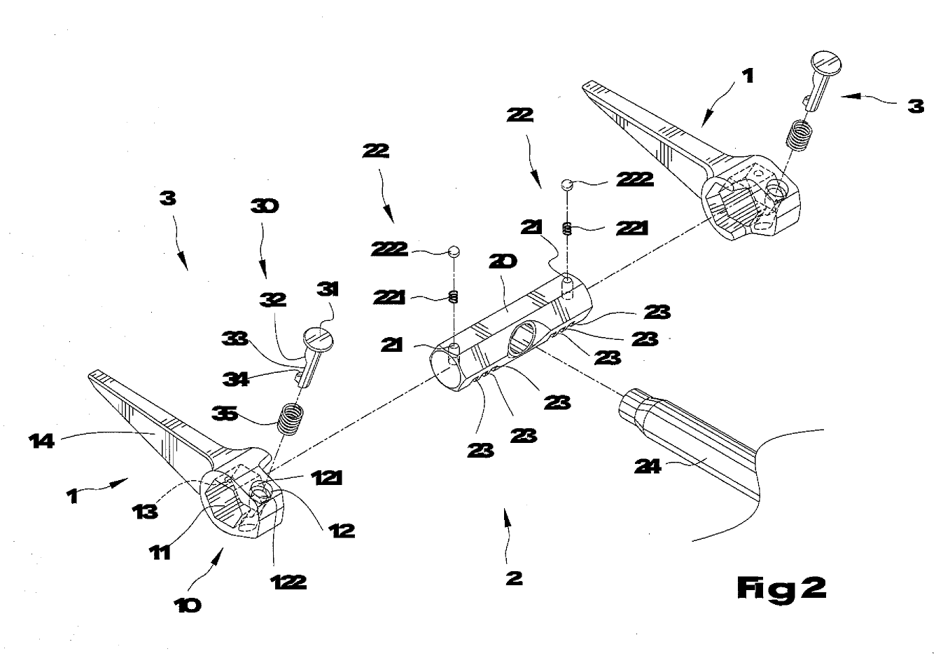

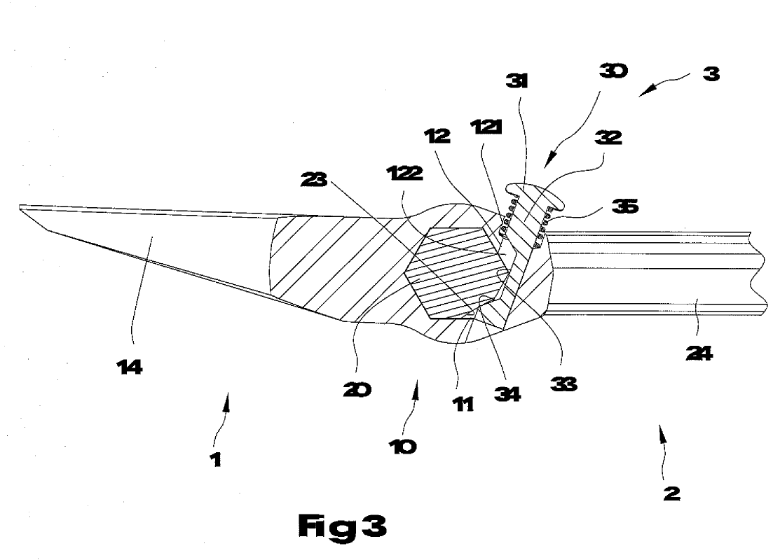

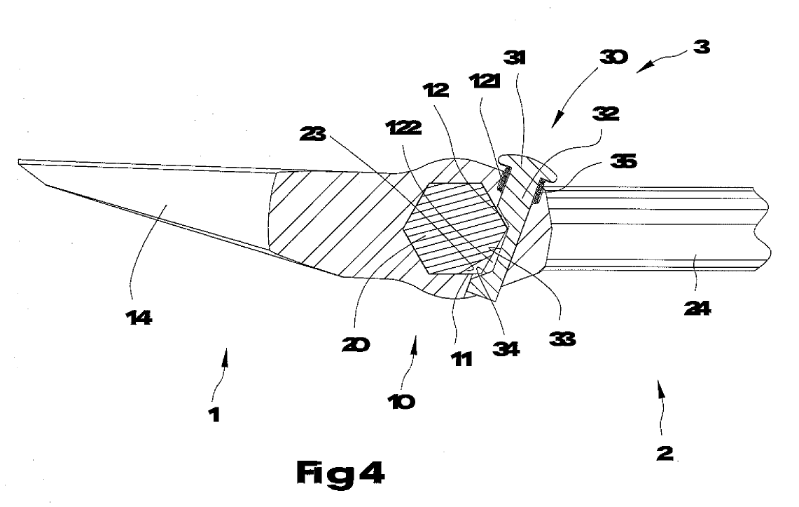

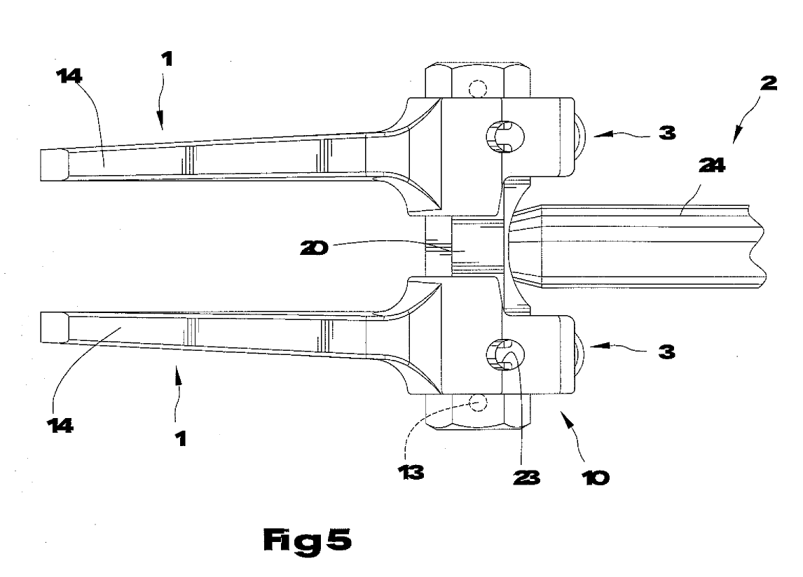

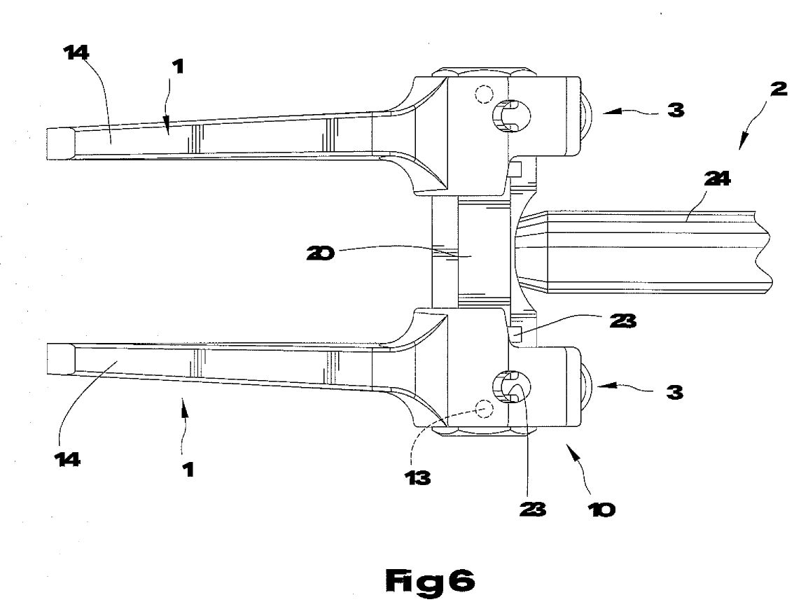

FIGS. 1 through 8 show a prying tool in accordance with a first embodiment of the present invention. The prying tool includes a shank 2 including an engaging portion 20 and a gripping portion 24 for user to hold during operation thereof. The gripping portion 24 is releasably connected transversely to the engaging portion 20 and connected at middle of the engaging portion 20. It is, however, contemplated that the engaging portion 20 and the gripping portion 24 are formed integrally.

The engaging portion 20 of the shank 2 includes a polygonal periphery having a plurality of retaining portions 23 thereon. The plurality of the retaining portions 23 are recesses and are inset on the engaging portion 20 of the shank 2. Further, the plurality of the retaining portions 23 are aligned with each other in a first direction and are disposed on one of the plurality of corners.

Two prongs 1 are moveably mounted on the engaging portion 20 of the shank 2 and each includes a connecting portion 11 and a working portion 14 projected from the connecting portion 10. The connecting portion 10 is connected to the engaging portion 20 of the shank 2. In this embodiment, each connecting portion 10 includes a through hole 11, and the engaging portion 20 of the shank 2 includes a proximal end inserted through the through hole 11 of one of the two prongs 1 and a distal end inserted through the through hole 11 of the other of the two prongs 1. Additionally, each connecting portion 10 includes a compartment 12 in communication with the through hole 11, and the compartment 12 in which a positioning device 3 is moveably received. Preferably, the compartment 12 includes a large diametrical section 121 and a small diametrical section 122. Further, the engaging portion 20 of the shank 2 includes two portions of the periphery received by the two compartments 12.

The two working portions 14 define a space (not numbered) therebetween such that an item (not shown) to be pried is received in the space. The space has a first size when the one of the two prongs 1 is positioned at the proximal end of the shank 2 and the other of the two prongs 1 is positioned at a distal end of the shank 2. Further, the space has a second size when the two prongs 1 are in proximity to each other. Since the prongs 1 are moveable, the size of the space is thus variable between the first and second sizes. Additionally, the two prongs 1 are adapted to be prevented from detaching from the engaging portion 20 of the shank 2 by two detent devices 22 respectively. The two detent devices 22 are disposed in proximity to the proximal and distal ends of the engaging portion 20 of the shank 2. In this embodiment, each of the two prongs 1 includes a dent 13, and each of the two detent devices 22 includes a cavity 21 on the engaging portion 20 of the shank 2, an elastic member 221 and a detent 222 received by the cavity 21. Further, the two detents 222 are adapted to be received by the two dents 13 respectively.

The two positioning devices 3 are utilized for holding the two prongs 1 stationary with respect to the engaging portion 20 of the shank 2 respectively. In this embodiment, the positioning devices 3 are operable to move between a first position and a second position. When the two prongs 1 are held stationary on the engaging portion 20, the two positioning devices 3 are operably moved to the first positions thereof. The two positioning devices 3 are engaged with two of the plurality of retaining portions 23 respectively. Further, when the two prongs are moveable on the engaging portion, the two positioning devices are operably moved to the second positions thereof.

Each of the two positioning devices 3 includes a controller 30 having a first section 32 and a second section 33 connected to the first section 32. The first section 32 has a first cross section and the second section 33 has a second cross section. The first cross section is larger than the second cross section. Each of the two positioning devices 3 further includes a hooking portion 34 on the second section 33. Preferably, the hooking portion 34 is a protrusion extended outward of the second section 33. Each of the two controllers 30 further includes an elastic element 35 surrounded. The elastic elements 32 are received by the large diametrical sections of the two compartments 12 respectively. Each of the two controllers 30 further includes an operation end 31 connected to the first section 32 for user to push during operation thereof.

When the two prongs 1 are held stationary on the engaging portion 20 of the shank 2, the hooking portions 34 of the two positioning devices 3 are abutted by the two of the plurality of retaining portions 23 respectively.

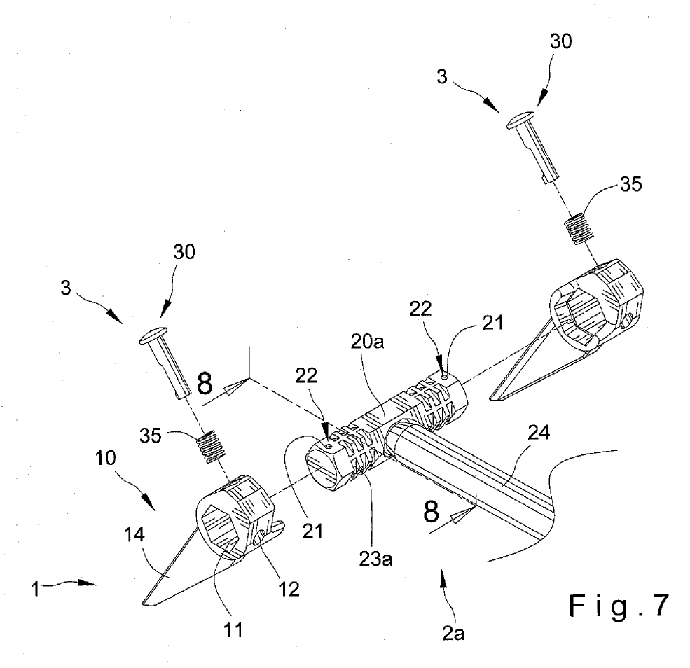

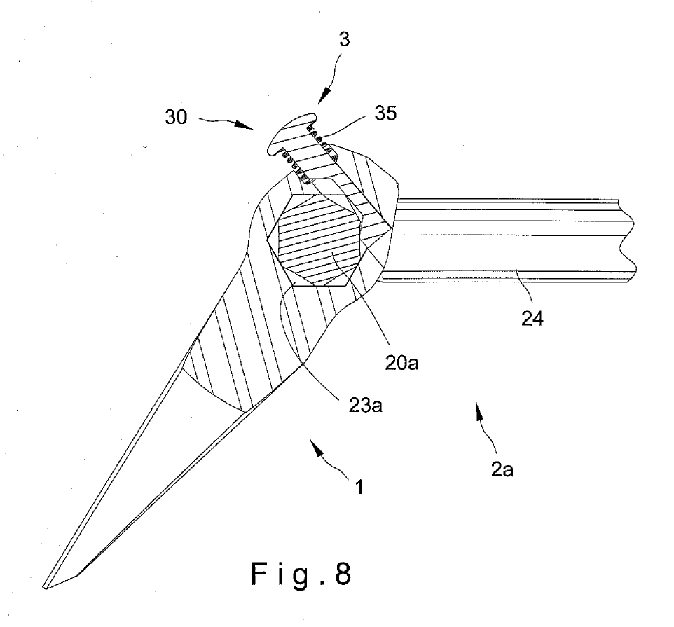

FIGS. 7 and 8 show a prying tool in accordance with a second embodiment of the present invention. This embodiment is similar to the first embodiment except that it includes a shank 2a having an engaging portion 20a having a plurality of retaining portions 23a. The plurality of retaining portions 23a are aligned with each other in a first direction and a second direction which is transverse to the first direction. In this embodiment, the plurality of the retaining portions 23a are disposed on the plurality of corners of the engaging portion 20a of the shank 2a. So even if the two prongs 1 are orientated with respect to the engaging portion 20a of the shank 2, the two prongs 1 are also adapted to be positioned near or further in relation to each other.

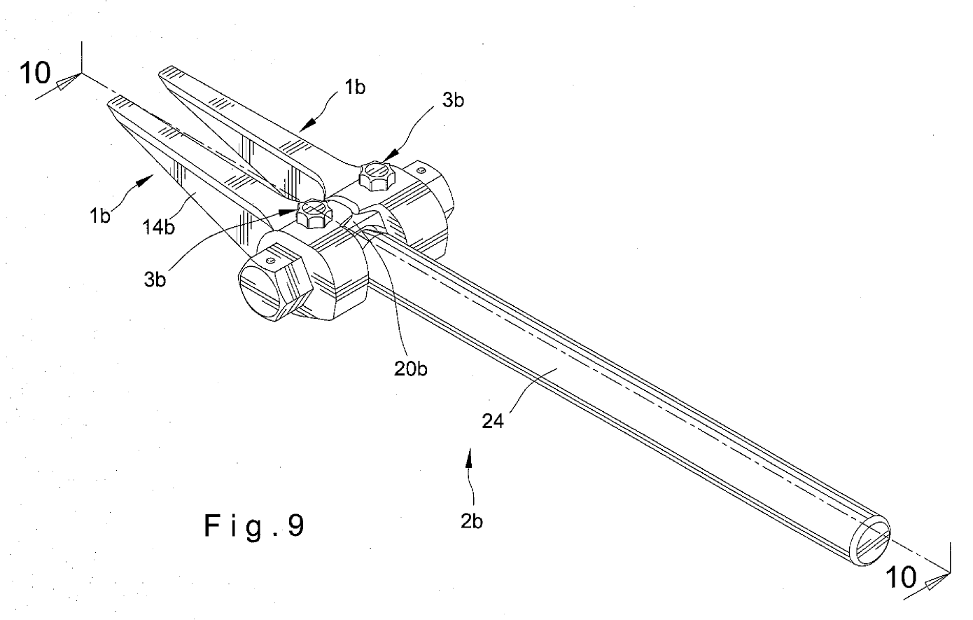

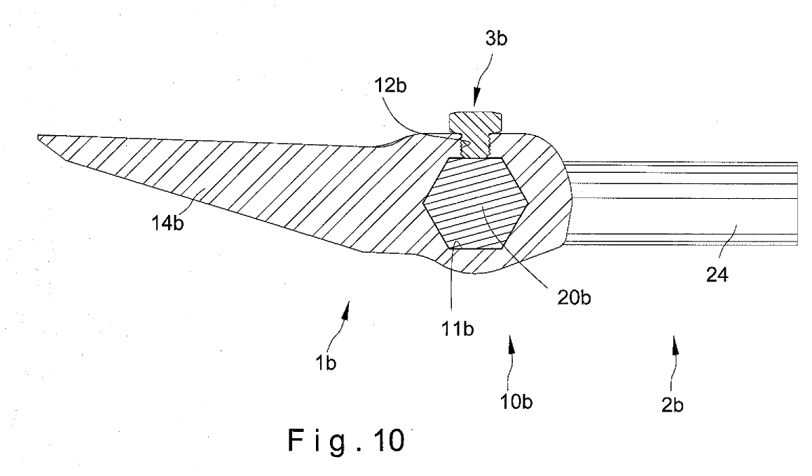

FIGS. 9 and 10 show a prying tool in accordance with a third embodiment of the present invention. The third embodiment differentiates from the first embodiment in that it includes two prongs 1b having a connecting portion 10b and a working portion 14b, a shank 2b having an engaging portion 20b, and two positioning devices 3b.

The connecting portion 10b of each of the two prongs 1b includes a through hole 11b, and the proximal end of the engaging portion 20b of the shank 2b is inserted through the through hole 11b of one of the two prongs 1b and the distal end of the engaging portion 20b of the shank 2b is inserted through the through hole 11b of the other of the two prongs 1b. The connecting portion 10b of each of the two prongs 1b further includes a compartment 12b in communication with the through hole 11b and in which one of two positioning devices 3b is moveably received.

Each of the two positioning devices 3b includes a thread and a terminal end. The engaging portion 20b of the shank 2b includes a polygonal periphery and defines a plurality of sides and one of the plurality of sides is selectively abutted by the terminal ends of the two positioning devices 3b.

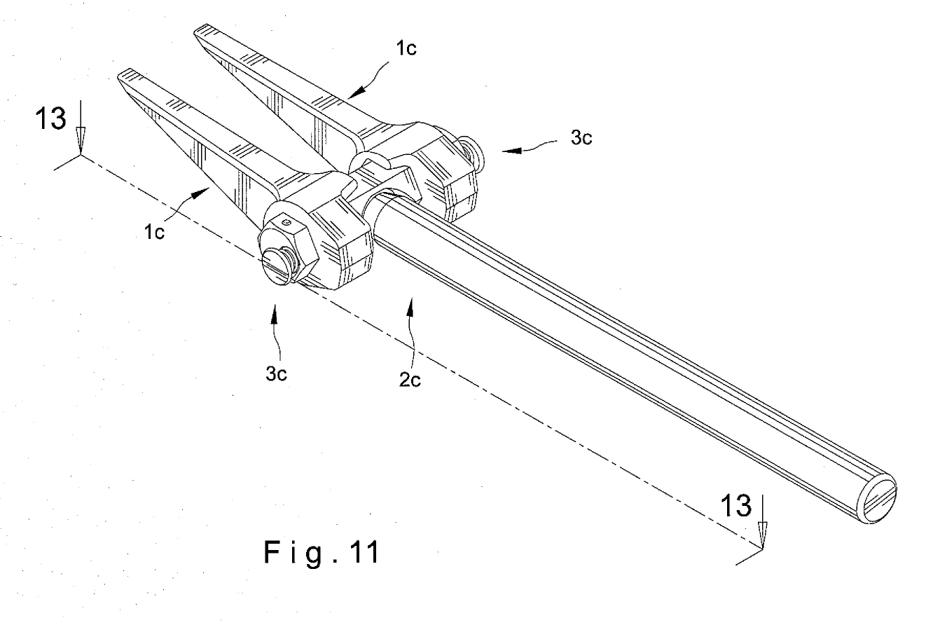

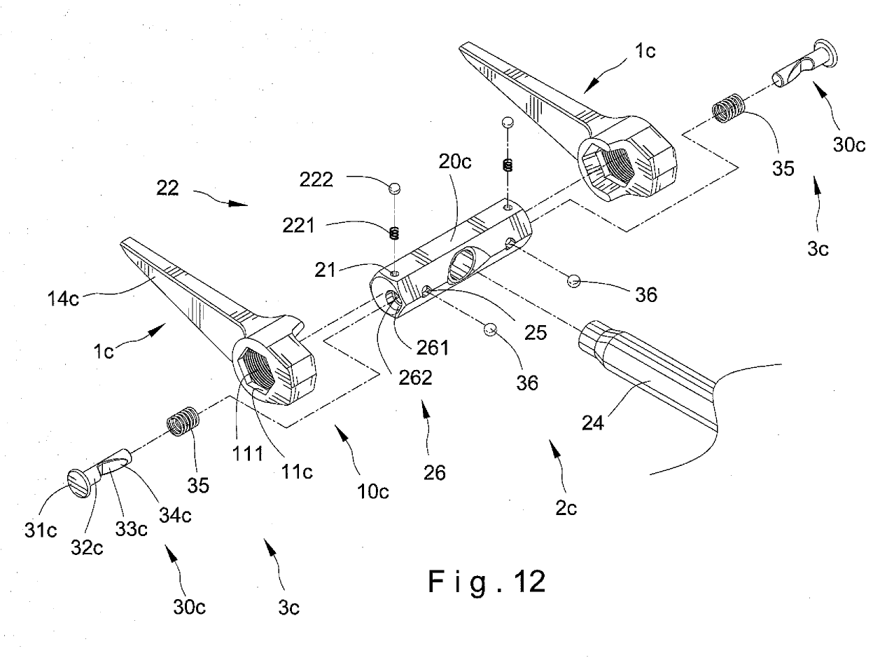

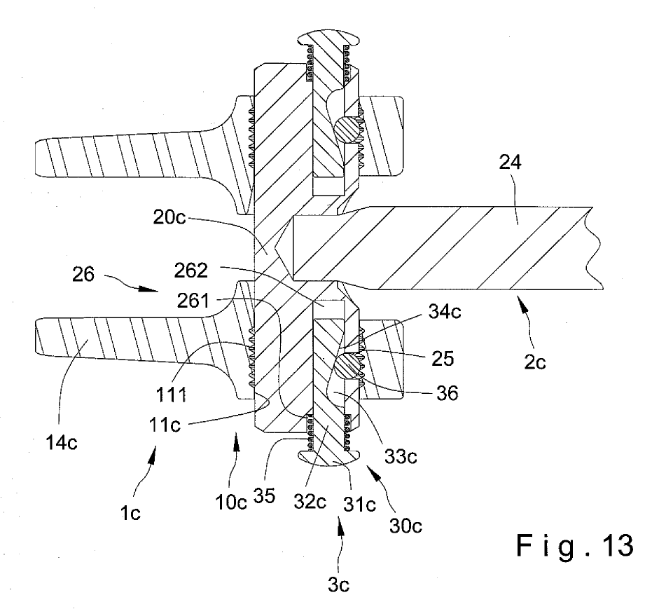

FIGS. 11 through 13 show a prying tool in accordance with a fourth embodiment of the present invention. The fourth embodiment differentiates from the first embodiment in that it includes two prongs 1c having a connecting portion 10c and a working portion 14c, a shank 2c having an engaging portion 20c which includes two holes 26 and two slots 25 extended transverse to and in communication with the two holes 26 respectively, and two positioning devices 3c moveably received in the two holes 26 respectively. Additionally, each of the two holes 26 includes a large diametrical section 261 and a small diametrical section 262.

The connecting portion 10c of each of the two prongs 1c includes a through hole 11c having an inner thread 111 circumferentially formed therein, and the proximal end of the engaging portion 20c of the shank 2c is inserted through the through hole 11c of one of the two prongs 1c and the distal end of the engaging portion 20c of the shank 2c is inserted through the through hole 11c of the other of the two prongs 1c.

Each of the two positioning devices 3c includes a controller 30c having a first section 32c and a second section 33c and the second section 33c includes two slanted surfaces extended inward of the controller 30c. The two slanted surfaces each has a proximal end connected to each other, and one of the two slanted surfaces has a distal end defining a hooking portion 34C. Each of the two positioning devices 3c further includes a retainer 36 received by one of the slots 25, and the retainer 36 is operably moved by one of the controllers 30c and selectively urged to abut a periphery of one of the through holes 11c. Each of the two controllers 30c includes an elastic element 35 surrounded. The elastic elements 35 are received in the large diametrical sections of the two holes 26 respectively. Each of the two controllers 30c further includes an operation end 31c connected to the first section 32 for user to push during operation thereof.

When the two prongs 1c are held stationary on the engaging portion 20c of the shank 2c, the hooking portions 34c of the two positioning devices 3c urge the two retainers 36 to abut against the peripheries of the two through holes 11c respectively.

While the specific embodiments have been illustrated and described, numerous modifications come to mind without significantly departing from the spirit of invention and the scope of invention is only limited by the scope of accompanying claims.

What is claimed is:

1. A prying tool comprising:
a shank including an engaging portion and a gripping portion connected transversely to the engaging portion; and
two prongs moveably mounted on the engaging portion of the shank and each including a connecting portion connected to the engaging portion of the shank and a working portion projected from the connecting portion, and with the two working portions defining a space therebetween, with the space having a first size when the one of the two prongs is positioned at a proximal end of the shank and the other of the two prongs is positioned at a distal end of the shank, and with the space having a second size when the two prongs are in proximity to each other, and with the size of the space being variable between the first and second sizes; and
two positioning devices for holding the two prongs stationary with respect to the engaging portion of the shank respectively, and with each of the two positioning devices being operable to move between a first position and a second position; and
wherein when the two prongs are held stationary on the engaging portion, the two positioning devices are operably moved to the first positions thereof and wherein when the two prongs are moveable on the engaging portion, the two positioning devices are operably moved to the second positions thereof.

2. The prying tool as claimed in claim 1 wherein the engaging portion of the shank includes a periphery having a plurality of retaining portions thereon, and wherein when the two prongs are held stationary on the engaging portion of the shank, the two positioning devices are engaged with two of the plurality of retaining portions respectively.

3. The prying tool as claimed in claim 2 wherein the plurality of the retaining portions are recesses and are inset on the engaging portion of the shank.

4. The prying tool as claimed in claim 3 wherein the plurality of the retaining portions are aligned with each other in a first direction.

5. The prying tool as claimed in claim 3 wherein the plurality of the retaining portions are aligned with each other in a second direction, and with the first direction transverse to the second direction.

6. The prying tool as claimed in claim 4 wherein the periphery of the engaging portion of the shank is polygonal and defines a plurality of sides and corners each interconnecting two of the plurality of sides, and wherein the plurality of the retaining portions are disposed on one of the plurality of corners.

7. The prying tool as claimed in claim 5 wherein the periphery of the engaging portion of the shank is polygonal and defines a plurality of sides and corners each interconnecting two of the plurality of sides, and wherein the plurality of the retaining portions are disposed on the plurality of corners.

8. The prying tool as claimed in claim 6 wherein each of the two positioning devices includes a controller having a first section and a second section connected to the first section, with the first section having a first cross section and the second section having a second cross section, and with the first cross section being larger than the second cross section, and wherein each of the two positioning devices further includes a hooking portion, with the hooking portion on the second section, and wherein when the two prongs are held stationary on the engaging portion of the shank, the hooking portions of the two positioning devices are abutted by the two of the plurality of retaining portions respectively.

9. The prying tool as claimed in claim 7 wherein each of the two positioning devices includes a controller having a first section and a second section connected to the first section, with the first section having a first cross section and the second section having a second cross section, and with the first cross section being larger than the second cross section, and wherein each of the two positioning devices further includes a hooking portion, with the hooking portion on the second section, and wherein when the two prongs are held stationary on the engaging portion of the shank, the hooking portions of the two positioning devices are abutted by the two of the plurality of retaining portions respectively.

10. The prying tool as claimed in claim 8 wherein the connecting portion of each of the two prongs includes a through hole, and wherein the proximal end of the engaging portion of the shank is inserted through the through hole of one of the two prongs and the distal end of the engaging portion of the shank is inserted through the through hole of the other of the two prongs, and wherein the connecting portion of each of the two prongs further includes a compartment in communication with the through hole, and wherein the engaging portion of the shank includes two portions of the periphery received by the two compartments, and wherein the two positioning devices are moveably received in the two compartments respectively.

11. The prying tool as claimed in claim 9 wherein the connecting portion of each of the two prongs includes a through hole, and wherein the proximal end of the engaging portion of the shank is inserted through the through hole of one of the two prongs and the distal end of the engaging portion of the shank is inserted through the through hole of the other of the two prongs, and wherein the connecting portion of each of the two prongs further includes a compartment in communication with the through hole, and wherein the engaging portion of the shank includes two portions of the periphery received by the two compartments, and wherein the two positioning devices are moveably received in the two compartments respectively.

12. The prying tool as claimed in claim 10 wherein each of the two controllers includes an elastic element surrounded, and wherein each of the two compartments includes a large diametrical section and a small diametrical section, and wherein the elastic elements are received by the large diametrical sections of the two compartments respectively.

13. The prying tool as claimed in claim 11 wherein each of the two controllers includes an elastic element surrounded, and wherein each of the two compartments includes a large diametrical section and a small diametrical section, and wherein the elastic elements are received by the large diametrical sections of the two compartments respectively.

14. The prying tool as claimed in claim 1 wherein each of the two positioning devices includes a thread and a terminal end.

15. The prying tool as claimed in claim 14 wherein the connecting portion of each of the two prongs includes a through hole, and wherein the proximal end of the engaging portion of the shank is inserted through the through hole of one of the two prongs and the distal end of the engaging portion of the shank is inserted through the through hole of the other of the two prongs, and wherein the connecting portion of each of the two prongs further includes a compartment in communication with the through hole, wherein the engaging portion of the shank includes a periphery, with the periphery being polygonal and defines a plurality of sides, and wherein the two positioning devices are moveably received by the two compartments, and wherein one of the plurality of sides is selectively abutted by the terminal ends of the two positioning devices.

16. The prying tool as claimed in claim 1 each of the two positioning devices includes a controller having a first section and a second section, with the second section including two slanted surfaces extended inward of the controller and each having a proximal end connected to each other, and with one of the two slanted surfaces having a distal end defining a hooking portion.

17. The prying tool as claimed in claim 16 wherein the connecting portion of each of the two prongs includes a through hole, and wherein the proximal end of the engaging portion of the shank is inserted through the through hole of one of the two prongs and the distal end of the engaging portion of the shank is inserted through the through hole of the other of the two prongs, and wherein the engaging portion of the shank includes two holes and two slots in communication with the two holes respectively, and with hole extended transverse to the slot, and wherein the two positioning devices are moveably received in the two holes respectively, and wherein each of the two positioning devices further includes a retainer received by the slot, with the retainer being operably moved by the controller and selectively urged to abut a periphery of the through hole, and wherein when the two prongs are held stationary on the engaging portion of the shank, the hooking portions of the two positioning devices urge the two retainers to abut against the peripheries of the two through holes respectively.

18. The prying tool as claimed in claim 17 wherein each of the through holes includes an inner thread circumferentially formed therein.

19. The prying tool as claimed in claim 17 wherein each of the two controllers includes an elastic element surrounded, and wherein each of the two holes includes a large diametrical section and a small diametrical section, and wherein the elastic elements are received in the large diametrical sections of the two holes respectively.
